(19) United States
(12) Patent Application Publication
(10) Pub. No.: US 2026/0259723 A1
(43) Pub. Date: Sep. 3, 2026

(54) APPARATUS AND METHOD FOR UPDATING SOFTWARE

(71) Applicant: University-Industry Cooperation Group of Kyung Hee University, Gyeonggi-do (KR)

(72) Inventors: JINSUNG CHO, Gyeonggi-do (KR); HEESEUNG SON, Gyeonggi-do (KR)

(21) Appl. No.: 18/873,430

(22) PCT Filed: Mar. 15, 2024
(86) PCT No.: PCT/KR2024/095549

§ 371 Date: Dec. 10, 2024

(30) Foreign Application Priority Data
May 25, 2023 (KR) 10-2023-0067926

(51) Int. Cl. G06F 8/65

(52) U.S. Cl. CPC G06F 8/65

(57) ABSTRACT

An apparatus for updating software includes a table generation module that generates a reference table for software to be updated, an update confirmation module that confirms whether an update event of the software occurs, and confirms one or more of the component type of update and the content type of update when the update event occurs, and an update performance module that perform update of the software according to one or more of the component type and the content type of the confirmed update based on the reference table.

This invention was made with government support under the national R&D program for supporting the present invention (1) (Project identification number: 1711183722; Project number: 2022R1F1A1063724; Ministry name: Ministry of Science and ICT; R&D management agency name: National Research Foundation of Korea; Research program name: Individual basic research (Ministry of Science and ICT); Research project name: Research on RTOS-based IoT system security technology; Contribution ratio: 1/2; Project performing agency name: Kyung Hee University (Global campus); Research period: 2023.03.01~2024.02.29) and national R&D program for supporting the present invention (2) (Project identification number: 1711198879; Project number: 00266615; Ministry name: Ministry of Science and ICT; R&D management agency name: Institute for Information & Communication Technology Planning & Evaluation; Research program name: Information, Communication and Broadcasting Innovative Talent Cultivation; Research project name: Graduate School of Security Convergence (Kyung Hee University); Contribution ratio: 1/2; Project performing agency name: Kyung Hee University Industry-Academic Cooperation Foundation; Research period: 2023.07.01~2023.12.31).

### BACKGROUND

### 1. Technical Field

The examples of the present invention are related to technology for updating software.

### 2. Background Art

In general, software is organically composed of various components such as functions, variables, and the like. These components constitute the overall context of the software, and when there is a dependency between the components of the software, changing a component at any location may destroy the overall context of the software. The context of the software is generated largely by a set of instructions and functions, and the components of each set have a strong dependency on adjacent components in the same set.

1 : void foo( ){
2 : instr1;
3 : instr2;
4 : instr3;
5 : }

In the context of the software, there is a strong dependency between each instruction, as instr2 is executed assuming that instr1 is executed, and in the same manner, instr3 is executed assuming that instr2 is executed, and the like. Similarly, there is a strong dependency on the types of the factor delivered and the value returned also between the function and function.

Accordingly, since modification of components at runtime during updating software is difficult to preserve the integrity of the overall context, a method of re-executing the entire process by terminating an executing old version of software and replacing it with a new version of software was used. However, in the field where real-time service is important, it is required to provide service without interruption when software is updated.

### SUMMARY

The examples of the present invention are to provide an apparatus and a method for updating software capable of real-time updating.

The apparatus for updating software according to one example disclosed, is apparatus for updating software, equipped with one or more processors, and a memory storing one or more programs executed by the one or more processors, which includes a table generation module that generates a reference table for software to be updated; an update confirmation module that confirms whether an update event of the software occurs, and confirms one or more of the component type of update and the content type of update when the update event occurs; and an update performance module that perform update of the software according to one or more of the component type and the content type of the confirmed update based on the reference table.

The table generation module may extract each function and global variables constituting the software, and map identification information of the extracted function and global variables with addresses where the function and global variables are stored in the memory to generate a reference table.

The update confirmation module may confirm whether the component type of update is a function or global variable, and confirm whether the content type of update is an internal modification or external modification, when the update event occurs.

The internal modification of the function may be a case in which only instructions inside the function are modified, and the external modification of the function may be a case in which a new function is added or the interface of the function is modified.

The update performance module, may load the updated function into the memory, and modify the address of the corresponding function into the address of the updated function in the reference table, when the update event is an internal modification of the function, and may load the updated function into the memory, and add an item for the updated function in the reference table, when the update event is an external modification of the function.

The internal modification of the global variable may be a case in which only the value of the global variable is modified, and the external modification of the global variable may be a case in which a new global variable is added or the type of the global variable is modified.

The update performance module, may load the updated global variable into the memory, and modify the address of the corresponding global variable into the address of the updated global variable in the reference table, when the update event is an internal modification of the global variable, and may load the updated global variable into the memory, and add an item for the updated global variable in the reference table, when the update event is an external modification of the global variable.

The update performance module may set the order of priority between the thread generated according to the update and the user instruction thread, while performing a thread that loads the updated function or global variable according to the component type and the content type of the confirmed update into the memory and a thread that modifies the reference table.

The update performance module may set the thread that loads the function or global variable into the memory to have a lower order of priority than the user instruction thread, and set the thread that modifies the reference table to have a higher order of priority than the user instruction thread.

The method for updating software according to one example disclosed, is a method performed in a computing device equipped with one or more processors, and a memory storing one or more programs executed by the one or more processors, which includes generating a reference table for software to be updated; confirming whether an update event of the software occurs, and confirming one or more of the component type of update and the content type of update when the update event occurs; and performing updating of the software according to one or more of the component type and the content type of the confirmed update based on the reference table.

According to the disclosed examples, by performing updating of software using a reference table that stores addresses of each function and global variables of the software, the software can be updated in real time without affecting a service being performed.

### BRIEF DESCRIPTION OF THE DRAWINGS

FIG. 1 is a diagram showing the configuration of the apparatus for updating software according to one example of the present invention

FIGS. 2A and 2B are diagrams showing a conventional direct memory reference and the indirect memory reference according to the disclosed example

FIG. 3 is a diagram schematically showing a performance status of updating in case that the type of update component is a function and the type of update content is an internal modification of the function in one example of the present invention

FIG. 4 is a diagram showing a state in which the internally modified function is called in one example of the present invention

FIG. 5 is a diagram schematically showing a performance status of updating in case that the type of update component is a function and the type of update content is an external modification of the function in one example of the present invention

FIG. 6 is a diagram showing a state in which the externally modified function is called in one example of the present invention

FIG. 7 is a flowchart for describing a method for updating software according to one example of the present invention

FIG. 8 is a block diagram for describing a computing environment including a computing device suitable for use in exemplary examples

### DETAILED DESCRIPTION

Hereinafter, specific embodiments of the present invention will be described with reference to drawings. The following detailed description is provided to help a comprehensive understanding of the method, apparatus, and/or system described in the present description. However, this is only an example, and the present invention is not limited thereto.

In describing the example of the present invention, when it is judged that a detailed description of the prior art related to the present invention may unnecessarily obscure the gist of the present invention, the detailed description will be omitted. In addition, the terms described below are terms defined in consideration of functions in the present invention may vary depending on the intention or practice or the like of the user or operator. Therefore, the definition should be based on the contents throughout the present entire description. The terms used in the detailed description are intended to describe the examples of the present invention only, and should not be limited. Unless used otherwise clearly, singular expressions include meanings of plural expressions. In the present description, expressions such as “comprising” or “equipped” are intended to refer to certain features, numbers, steps, operations, elements, parts or combinations thereof, and they should not be construed to exclude the presence or possibility of one or more other features, numbers, steps, operations, elements, parts of combinations thereof, other than those described.

In addition, the terms of the first, the second, and the like can be used to describe various components, but the components should not be limited by the terms. The terms may be used for the purpose of distinguish one component from other components. For example, without departing from the scope of the present invention, the first component may be named the second component, and similarly, the second component may also be named the first component.

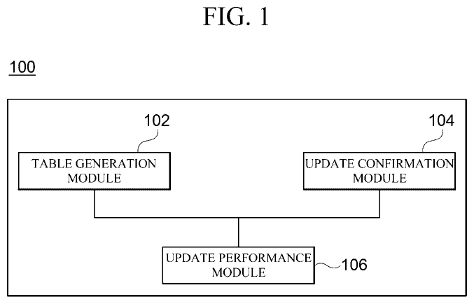

FIG. 1 is a diagram showing the configuration of the apparatus for updating software according to one example of the present invention.

Referring to FIG. 1, the apparatus for updating software (100) may include a table generation module (102), an update confirmation module (104) and an update performance module (106). The apparatus for updating software (100) may be apparatus for performing updating of software. The apparatus for updating software (100) may be prepared in a computing device equipped with software. The apparatus for updating software (100) may include one or more memories.

The table generation module (102) may generate a reference table for the software to be updated. The reference table may be stored by mapping the identification information of the function and global variables and the address values actually stored in the memories of the function and global variables for each function and global variables that constitute the software. The table generation module (102) may extract each function and each global variable which constitute the software, and map the identification information of the extracted function and global variables with the address values actually stored in the memories of the function and global variables to generate the reference table. The table generation module (102) may load the reference table in the memory.

In the disclosed example, indirect memory reference is made for the function or global variables of the software through the reference table. In other words, in general, in the software, when calling the function or global variables, direct memory reference is made, but in the disclosed example, indirect memory reference is made through the reference table.

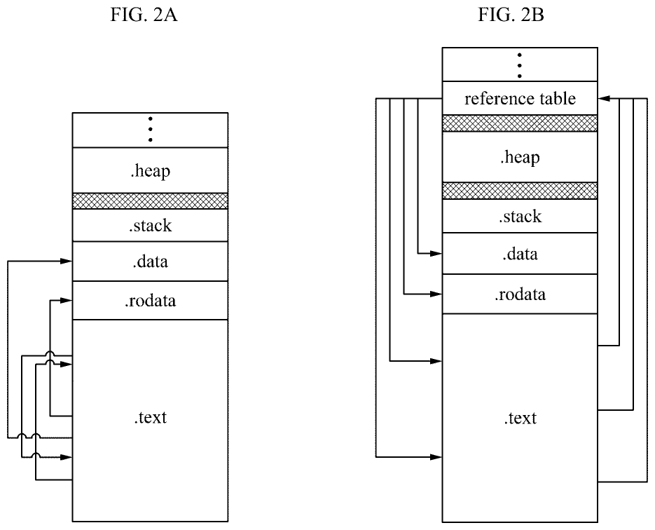

FIGS. 2A and 2B are diagrams showing a conventional direct memory reference and the indirect memory reference according to the disclosed example. Referring to FIGS. 2A and 2B, in the past, when the function or global variables of the software call another function or global variable, the location in the memory where the corresponding function or global variables are stored is directly referred (FIG. 2A).

On the other hand, in the disclosed example, when the function or global variables of the software call another function or global variable, a process of confirming the address values actually stored of the corresponding function or global variables in the reference table is passed through, so indirect reference is made.

The update confirmation module (104) may confirm whether an update event of the software occurs. The update confirmation module (104) may be connected with an external server (unshown) that manages updating of the software. The update confirmation module (104) may confirm whether an update event from the external server occurs.

The update confirmation module (104) may confirm what components of the update are (confirm the types of the components). In other words, the update confirmation module (104) may confirm whether the components of the update are for the function or for the global variables. The update confirmation module (104) may confirm the types of the update contents (for example, internal modification or external modification), after confirming the types of the components of the update.

In one example, the update confirmation module (104) may confirm whether the update contents are an internal modification or external modification of the function, when the component of the update is the function. Herein, the internal modification of the function may mean a case in which only the instruction inside the function is modified. In addition, the external modification of the function may mean a case in which a new function is added or an interface is modified.

In one example, the update confirmation module (104) may confirm whether the update contents are an internal modification or external modification of the function, when the component of the update is the global variable. Herein, the internal modification of the global variable may mean a case in which only the value of the corresponding global variable is modified. In addition, the external modification of the global variable may mean a case in which a new global variable is added or the type of the global variable is modified.

The update performance module (106) may perform update of the software according to the matters confirmed in the update confirmation module (104). The update performance module (106) may perform update of the software according to the type of the update component and the type of the update content.

Specifically, the update performance module (106) may load the updated function (i.e., hotpatched function), when the type of the update component is the function, and the type of the update content is an internal modification of the function, and change the address of the corresponding function into the address of the updated function from the conventional address (i.e., address of the function before updating) in the reference table of the software.

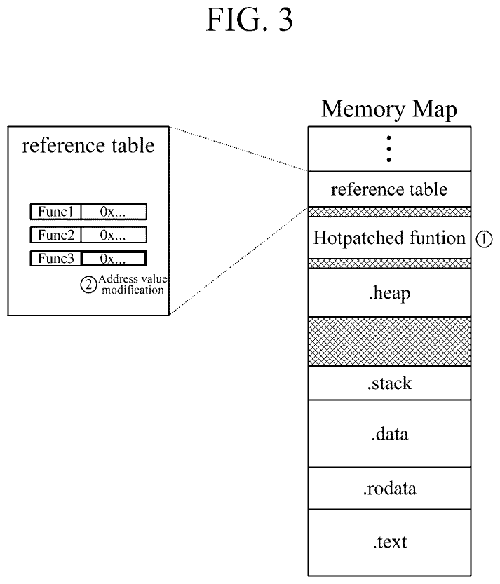

FIG. 3 is a diagram schematically showing a performance status of updating in case that the type of update component is a function and the type of update content is an internal modification of the function in one example of the present invention. Referring to FIG. 3, when the internal modification of Function 3 (Func3) is updated in the software, the update performance module (106) may load the updated function (i.e., hotpatched function) in the memory (\textcircled{1}), and modify the address of Function 3 (Func3) into the address of updated memory (\textcircled{2}). Then, the updated function may be loaded into a different area of the memory from the conventional function.

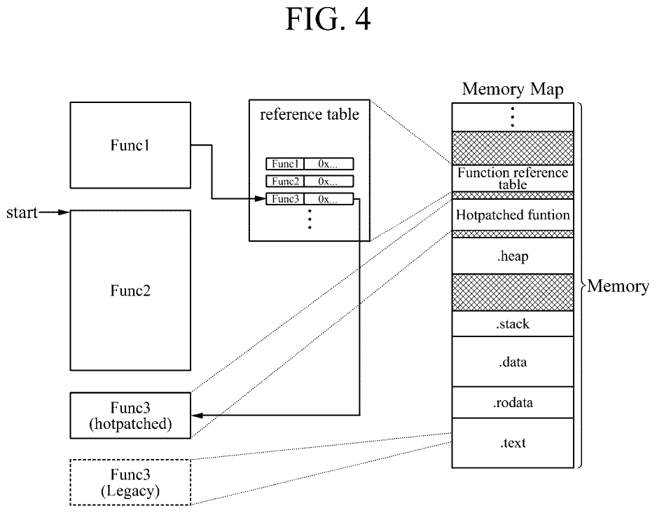

FIG. 4 is a diagram showing a state in which the internally modified function is called in one example of the present invention. Referring to FIG. 4, when Function 1 (Func1) calls Function 3 (Func3) in the software, Function 1 (Func1) may call the updated Function 3 (Func3_hopatched) by confirming the modified address value of Function 3 (Func3) in the reference table.

Herein, the storage area (address) of the function before updated (Func3_legacy) is a text area of the memory, but after updated, it may be loaded in an area of a memory different from it, and accordingly, the address of Function 3 (Func3) is modified into the address of the updated memory in the reference table.

On the other hand, even in the case in which the type of the update component is the global variable, and the type of the update content is the internal modification of the global variable (for example, modification of the value of the global variable), updating may be performed in the same or similar way to the internal modification of the function. In other words, the update performance module (106) may load the updated global variable in the memory, and modify the address of the corresponding global variable into the address of the updated global variable from the conventional address in the reference table of the software.

In addition, the update performance module (106) may have a problem in a dependency between functions, when the type of the update component is the function and the type of the update content is the external modification of the function, and therefore, the update performance module (106) may load the updated function (i.e., hotpatched function) in the memory, and add items (identification information of the function and the address value actually stored in the memory of the function) for the updated function to the reference table of the software.

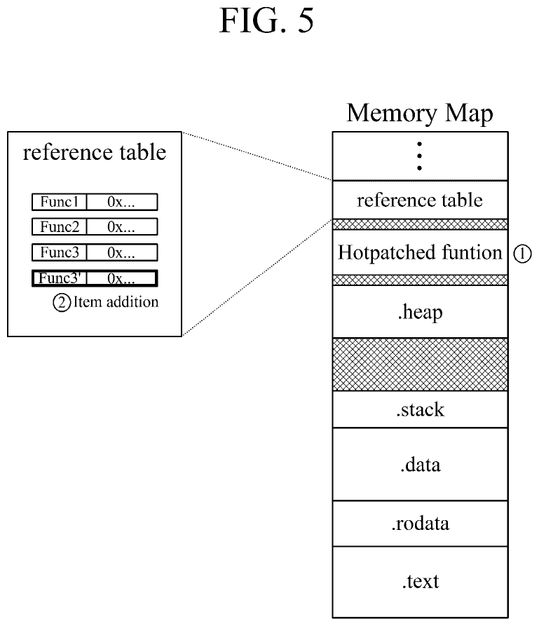

FIG. 5 is a diagram schematically showing a performance status of updating in case that the type of update component is a function and the type of update content is an external modification of the function in one example of the present invention. Referring to FIG. 5, when the external modification of Function 3 (Func 3) is updated in the software, the update performance module (106) may load the updated function (i.e., hotpatched function) in the memory (\textcircled{1}), and add items for the updated Function 3 (Func3′) in the reference table. Then, the updated function may be loaded in a different area of the memory from the conventional function.

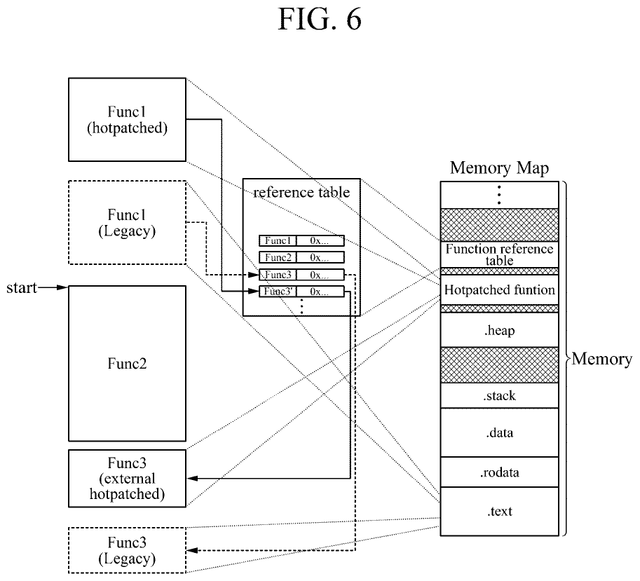

FIG. 6 is a diagram showing a state in which the externally modified function is called in one example of the present invention. Herein, a case in which Function 1 (Func1) calls Function 3 (Func3) has been used as an example, and a case in which the external modification (for example, interface modification) in the Function 3 (Func3) is done has been shown.

Referring to FIG. 6, when Function 3 (Func3) is modified externally, Function 1 (Func1) that calls the externally modified Function 3 (Func3) should be updated accordingly. Then, the updated Function 1 (Func1_hotpatched) may be loaded in a certain area of the memory. Herein, when the updated Function 1 (Func1_hotpatched) calls the externally modified Function 3 (Func1_hotpatched), the externally modified Function 3 (Func1_hotpatched) may be called, after finding items of the newly added externally modified Function 3 (Func3′) in the reference table and confirming the address value thereof. If, the conventional version of Function 1 (Func1_legacy) calls Function 3, the conventional version of Function 3 (Func3_legacy) may be called, after finding the items of the conventional version of Function 3 (Func3) in the reference table and confirming the address value thereof.

On the other hand, also when the type of the update component is the global variable, and the type of the update content is the external modification of the global variable (for example, modification of the type of the global variable or addition of a new global variable, etc.), updating may be performed in the same or similar way to the external modification of the function. In other words, the update performance module (106) may load the updated global variable and add an item for the updated global variable in the reference table of the software.

The update performance module (106) may confirm whether there is a thread performed according to the instruction of the user in a computing device during updating of the software (user instruction thread). The update performance module (106) may set the order of priority between the thread occurring according to the update of the software and the user instruction thread. Then, the update performance module (106) may set the order of priority with the user instruction thread differently depending on the type of the thread occurring according to the update of the software.

Specifically, the update performance module (106) may confirm whether there is the user instruction thread, when the updated function or global variable is loaded in the memory, and when there is the user instruction thread, set the order of priority of the thread loading the updated function or global variable in the memory lower than the order of priority of the user instruction variable.

In addition, the update performance module (106) may set the order of priority of the reference table modification thread higher than the order of priority of the user instruction thread, when the reference table of the memory should be modified according to the update of the function or global variables. In other words, the reference table modification may be made to be executed with precedence over it, even if there is the user instruction thread.

According to the disclosed example, by performing the update of the software using the reference table that stores the addresses of each of the function and global variables of the software, software may be updated in real time without affecting the service being performed. In this case, it will be possible to provide a software service in any time in a real-time system such as power plants and Internet of Things (IoT) and the like where service interruption is difficult.

In the present description, the term module may mean a functional and structural combination of hardware to perform the technical idea of the present invention and software to operate the hardware. For example, the “module” may mean a logical unit of a predetermined code and a hardware resource for performing the predetermined code, and does not necessarily mean a physically connected code, or mean one type of hardware.

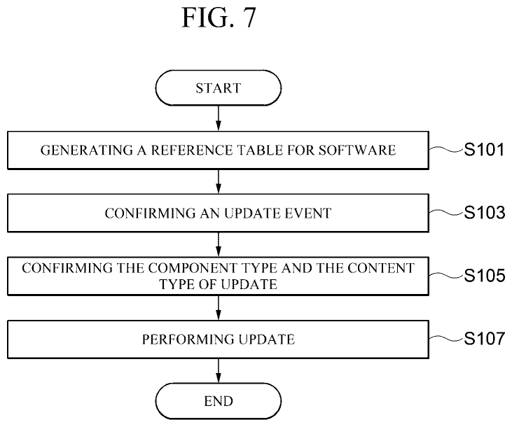

FIG. 7 is a flowchart for describing a method for updating software according to one example of the present invention. In the flowchart shown, the method is described by dividing into a plurality of steps, but at least some of the steps may be performed in a different order, or performed together in combination with other steps, omitted, or performed by dividing into detailed steps, or performed by adding one or more steps that are not shown.

Referring to FIG. 7, the apparatus for updating software (100) may generate a reference table for software to be updated (S 101). The apparatus for updating software (100) may extract each function and each global variable constituting software, and map the identification information of the extracted function and global variables with the address values where the function and global variables are actually stored in the memory to generate the reference table.

Next, the apparatus for updating software (100) may confirm whether an update event of the software occurs (S 103), and confirm the type of the component of the update and the type of the update content when the update event occurs (S 105). Then, the apparatus for updating software (100) may perform update using the reference table depending on the confirmed type of the component of the update and the type of the update content (S 107).

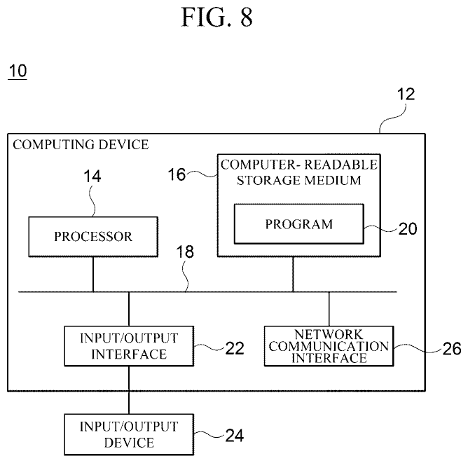

FIG. 8 is a block diagram for describing a computing environment (10) including a computing device suitable for use in exemplary examples. In the example shown, each component may have different functions and capabilities other than those described below, and may include additional components other than those described below.

The illustrated computing environment (10) includes a computing device (12). In one example, the computing device (12) may be the apparatus for updating software (100).

The computing device (12) includes at least one processor (14), a computer readable storage medium (16) and a communication bus (18). The processor (14) may allow the computing device (12) to operate according to the illustrative example mentioned above. For example, the processor (14) may execute one or more programs stored in the computer readable storage medium (16). The one or more programs may include one or more computer executable instructions, and the computer executable instructions, when executed by the processor (14), may be configured to allow the computing device (12) to perform operations according to the illustrative example.

The computer readable storage medium (16) is configured to store a computer executable instruction or program code, program data and/or other suitable forms of information. The program (20) stored in the computer readable storage medium (16) includes a set of executable instructions by the processor (14). In one example, the computer readable storage medium (16) may be a memory (volatile memory such as a random-access memory, non-volatile memory, or a suitable combination thereof), one or more magnetic disk storage devices, optical disk storage devices, flash memory devices, other forms of storage media that are accessed by the computing device (12) and store desired information, or a suitable combination thereof.

The communication bus (18) interconnects other various components of the computing device (12) by including the processor (14) and computer readable storage medium (16).

The computing device (12) may include one or more input/output interfaces (22) that provide interfaces for one or more input/output devices (24) and one or more network communication interfaces (26). The input/output interfaces (22) and network communication interfaces (26) are connected to the communication bus (18). The input/output devices (24) may be connected to other components of the computing device (12) through the input/output interfaces (22). The illustrative input/output devices (24) may include input devices such as pointing devices (mouse or trackpad, etc.), keyboards, touch input devices (touchpad or touchscreen, etc.), voice or sound input devices, various kinds of sensor devices and/or photographing devices, and/or output devices such as display devices, printers, speakers, and/or network cards. The illustrative input/output devices (24) may be included inside the computing device (12) as one component, and may be connected with the computing device (12) as a separate device distinguished from the computing device (12).

Representative examples of the present invention are described in detail above, but those skilled in the art to which the present invention pertains will understand that various modifications can be made to the afore-mentioned examples within limits without departing from the scope of the present invention. Therefore, the scope of the present invention should not be limited to the examples described, and should be determined by not only claims described later but also equivalents to these claims.

1. Apparatus for updating software, comprising:
one or more processors; and
a memory storing one or more programs executed by the one or more processors;
a table generation module configured to generate a reference table for software to be updated;
an update confirmation module configured to confirm whether an update event of the software occurs, and confirms one or more of the component type of update and the content type of update when the update event occurs; and
an update performance module configured to perform update of the software according to one or more of the component type and the content type of the confirmed update based on the reference table.

2. The apparatus for updating software according to claim 1, wherein the table generation module is configured to extract each function and global variables constituting the software, and map identification information of the extracted function and global variables with addresses where the function and global variables are stored in the memory to generate a reference table.

3. The apparatus for updating software according to claim 2, wherein the update confirmation module is configured to confirm whether the component type of update is a function or global variable, and confirm whether the content type of update is an internal modification or external modification, when the update event occurs.

4. The apparatus for updating software according to claim 3, wherein the internal modification of the function is a case in which only instructions inside the function are modified, and
the external modification of the function is a case in which a new function is added or the interface of the function is modified.

5. The apparatus for updating software according to claim 4, wherein the update performance module is configured to:
load the updated function into the memory, and modify the address of the corresponding function into the address of the updated function in the reference table, when the update event is an internal modification of the function; and
load the updated function into the memory, and add an item for the updated function in the reference table, when the update event is an external modification of the function.

6. The apparatus for updating software according to claim 3, wherein the internal modification of the global variable is a case in which only the value of the global variable is modified, and
the external modification of the global variable is a case in which a new global variable is added or the type of the global variable is modified.

7. The apparatus for updating software according to claim 6, wherein the update performance module is configured to:
load the updated global variable into the memory, and modify the address of the corresponding global variable into the address of the updated global variable in the reference table, when the update event is an internal modification of the global variable; and
load_the updated global variable into the memory, and add an item for the updated global variable in the reference table, when the update event is an external modification of the global variable.

8. The apparatus for updating software according to claim 3, wherein the update performance module is configured to set the order of priority between the thread generated according to the update and the user instruction thread, while performing a thread that loads the updated function or global variable according to the component type and the content type of the confirmed update into the memory and a thread that modifies the reference table.

9. The apparatus for updating software according to claim 8, wherein the update performance module is configured to set the thread that loads the function or global variable into the memory to have a lower order of priority than the user instruction thread, and set the thread that modifies the reference table to have a higher order of priority than the user instruction thread.

10. A method for updating software, the method performed in a computing device equipped with one or more processors and a memory storing one or more programs executed by the one or more processors, the method comprising:
generating a reference table for software to be updated;
confirming whether an update event of the software occurs, and confirming one or more of the component type of update and the content type of update when the update event occurs; and
performing updating of the software according to one or more of the component type and the content type of the confirmed update based on the reference table.

11. The method for updating software according to claim 10, wherein the generating of the reference table comprises:
extracting each function and global variables constituting the software; and
mapping identification information of the extracted function and global variables with addresses where the function and global variables are stored in the memory to generate a reference table.

12. The method for updating software according to claim 11, wherein the confirming comprises:
when the update event occurs, confirming whether the component type of update is a function or global variable; and
confirming whether the content type of update is an internal modification or external modification.

13. The method for updating software according to claim 12, wherein the internal modification of the function is a case in which only instructions inside the function are modified, and
the external modification of the function is a case in which a new function is added or the interface of the function is modified.

14. The method for updating software according to claim 13, wherein the performing updating comprises loading the updated function into the memory, and modifying the address of the corresponding function into the address of the updated function in the reference table, when the update event is an internal modification of the function, and
loading the updated function into the memory, and adding an item for the updated function in the reference table, when the update event is an external modification of the function.

15. The method for updating software according to claim 12, wherein the internal modification of the global variable is a case in which only the value of the global variable is modified, and the external modification of the global variable is a case in which a new global variable is added or the type of the global variable is modified.

16. The method for updating software according to claim 15, wherein the performing of the updating comprises:
loading the updated global variable into the memory, and modifying the address of the corresponding global variable into the address of the updated global variable in the reference table, when the update event is an internal modification of the global variable; and
loading the updated global variable into the memory, and adding an item for the updated global variable in the reference table, when the update event is an external modification of the global variable.

17. The method for updating software according to claim 12, wherein the performing of the updating further comprises setting the order of priority between the thread generated according to the update and the user instruction thread, while performing a thread that loads the updated function or global variable according to the component type and the content type of the confirmed update into the memory and a thread that modifies the reference table.

18. The method for updating software according to claim 17, wherein the setting of the order of the priority sets the thread that loads the function or global variable into the memory to have a lower order of priority than the user instruction thread, and sets the thread that modifies the reference table to have a higher order of priority than the user instruction thread.

19. A computer program stored in a non-transitory computer readable storage medium, the computer program comprising one or more instructions executed by a computing device having one or more processors, the one or more instructions comprising:
an instruction of generating a reference table for software to be updated;
an instruction of confirming whether an update event of the software occurs, and confirming one or more of the component type of update and the content type of update when the update event occurs; and
an instruction of performing updating of the software according to one or more of the component type and the content type of the confirmed update based on the reference table.
